(19) United States
(12) Patent Application Publication
(10) Pub. No.: US 2011/0222118 A1
(43) Pub. Date: Sep. 15, 2011

(54) PRINTING APPARATUS, PRINTING APPARATUS CONTROL METHOD, AND CONTROL PROGRAM AND CONTROL APPARATUS FOR PRINTING APPARATUS

(75) Inventors: Masanori Mukaiyama, Minamiminowa-mura (JP); Takeshi Takeuchi, Matsumoto-shi (JP); Kazuki Tadachi, Matsumoto-shi (JP); Atsushi Suzuki, Matsumoto-shi (JP)

(73) Assignee: SEIKO EPSON COPRPORATION, Shinjuku-ku (JP)

(21) Appl. No.: 13/045,417

(22) Filed: Mar. 10, 2011

(30) Foreign Application Priority Data
Mar. 11, 2010 (JP) 2010-054095

(51) Int. Cl. G06F 3/12

(52) U.S. Cl. 358/1.15

(57) ABSTRACT

A printing apparatus with a plug-and-play execution unit includes a plug-and-play control unit and a permission receiving unit. The plug-and-play execution unit can perform predetermined communication processing with an external control apparatus, and the predetermined communication processing is triggered by a connection with the control apparatus when the connection is established via a predetermined communication path. The plug-and-play control unit is configured to prohibit the plug-and-play execution unit from operating in a case where an instruction for activating the printing apparatus according to a specific operation mode is received from an outside source, so that the plug-and-play execution unit is prevented from performing the communication processing. The permission receiving unit is configured to receive permission for execution of plug and play. In a case where the permission for execution is received, the plug-and-play control unit cancels the prohibition of operation of the plug-and-play execution unit.

### BACKGROUND

1. Technical Field

The present invention relates to a printing apparatus, a method of controlling the printing apparatus, a control program and a control apparatus for the printing apparatus.

2. Related Art

A user performs initialization (setup of a printer) for making a printer ready (print ready), for example, after purchasing the printer. In this case, the user installs predetermined software (a printer driver or the like) in a personal computer (PC). Then, according to a guide screen for setup that is caused to appear on a display of the PC, the user establishes a connection between the PC and the printer using a universal serial bus (USB) cable or the like, and performs operations such as pressing down a power button of the printer. Also, under conditions where the PC and the printer are connected with each other and both the PC and the printer are supplied with power, the connection in such a manner triggers automatic starting of predetermined communication processing required for performing setup between the PC and the printer, that is, so-called plug and play is realized.

Here, as a technique regarding plug and play, there is known an information processing apparatus in which, before a device driver running on an operating system (OS) is deleted, software related to a device corresponding to the device driver is removed from a device manager of the OS (see JP-A-2008-15912). This enables the device to be not detected by a plug-and-play function of the OS even if a user leaves the device connected to the computer after the device driver is deleted.

When the setup mentioned above is performed, no problem arises if a user follows the proper procedure. However, the user may not necessarily perform the setup in accordance with the proper procedure. For example, it could be that the user connects a printer in the powered state to a PC before installing the above-mentioned software. In this case, a plug-and-play function could occur at the time point of the connection. This sometimes makes it impossible to accomplish setup in accordance with the proper procedure (the setup does not come to a proper end). That is, in spite of efforts directed toward accomplishment of setup in such a manner as to be easy and reliable for any user, the plug-and-play function of a PC or a printer contrarily has sometimes prevented accomplishment of such setup.

### SUMMARY

An advantage of some aspects of the invention is that it provides a printing apparatus, a method of controlling the printing apparatus, a control program and a control apparatus for the printing apparatus that can properly perform predetermined setting for the printing apparatus, regardless of whether the procedure performed by a user is proper or not, to enable the load on the user to be reduced.

An aspect of the invention provides a printing apparatus, with a plug-and-play execution unit, that includes a plug-and-play control unit and a permission receiving unit. The plug-and-play execution unit can perform predetermined communication processing with an external control apparatus, and the predetermined communication processing is triggered by a connection with the control apparatus when the connection is established via a predetermined communication path. The plug-and-play control unit is configured to prohibit the plug-and-play execution unit from operating in a case where an instruction for activating the printing apparatus according to a specific operation mode is received from an outside source, so that the plug-and-play execution unit is prevented from performing the communication processing even with the control apparatus and the printing apparatus connected. The permission receiving unit is configured to receive permission for execution of plug and play via the communication path from the control apparatus. In a case where the permission for execution is received, the plug-and-play control unit cancels the prohibition of operation of the plug-and-play execution unit to cause the plug-and-play execution unit to perform the communication processing.

According to the aspect of the invention, in the case where the printing apparatus receives the instruction for activating the printing apparatus according to a specific operation mode from an outside source, initially, plug and play is prohibited. Then, when the permission for execution of plug and play is received from the control apparatus, the prohibition of plug and play is cancelled, so that processing corresponding to the plug and play (the predetermined communication processing mentioned above) is started between the control apparatus and the printing apparatus. Accordingly, the predetermined communication processing is started at an optimum timing regardless of whether the procedure performed by a user is proper or improper. As a result, predetermined setting for the printing apparatus is properly performed. It is to be noted that the above-mentioned communication processing may be communication required for the control apparatus to set the printing apparatus to a print ready state.

The printing apparatus may include a permission generating unit configured to generate permission for execution of plug and play. Further, the plug-and-play control unit may be configured to cancel the prohibition of operating of the plug-and-play execution unit in a case where the permission generating unit generates permission for execution. That is, it may be possible for the printing apparatus not only to cancel the prohibition of plug and play in response to execution permission transmitted from the control apparatus but also to itself issue execution permission to cancel the prohibition of plug and play.

One aspect of the invention is implemented not only as the printing apparatus but also as an apparatus (control apparatus) that is connected with the printing apparatus via a communication path and is configured to control the printing apparatus. In this case, the control apparatus may be configured as follows. The control apparatus with a plug-and-play execution unit includes a plug-and-play control unit and a permission generating unit. The plug-and-play execution unit can perform predetermined communication processing with an external printing apparatus, and the predetermined communication processing is triggered by a connection with the printing apparatus when the connection is established via a predetermined communication path. The plug-and-play control unit is configured to prohibit the plug-and-play execution unit from operating, when performing predetermined setting for the printing apparatus, so that, in a case where signal transmission as part of the communication processing is performed via the communication path from the printing apparatus, a response to the signal transmission is put on hold to prevent the communication processing from progressing. The permission generating unit is configured to generate permission for execution of plug and play at a predetermined timing. In a case where the permission generating unit generates permission for execution, the plug-and-play control unit cancels the prohibition of operation of the plug-and-play execution unit to cause the plug-and-play execution unit to advance the progress of the communication processing.

With this configuration, when performing predetermined setting for the printing apparatus, the control apparatus initially prohibits plug and play. Then, in the case where signal transmission is performed to the control apparatus from the printing apparatus connected via the communication path by a plug-and-play function of the printing apparatus, a response to the signal transmission on the control apparatus side is put on hold to prevent communication processing involved in plug and play from progressing. The control apparatus itself generates permission for execution of plug and play to cancel the prohibition of plug and play. Accordingly, the predetermined communication processing is started at an optimum timing regardless of whether the procedure performed by a user is proper or improper. As a result, predetermined setting for the printing apparatus is performed properly.

Also, in this case, the communication processing may be communication required for the control apparatus to set the printing apparatus to a print ready state. In addition, the permission generating unit may generate the permission for execution at a timing when the printing apparatus for which the predetermined setting is to be performed is specified via the communication path.

The technical idea of one aspect of the invention may be implemented as forms other than the printing apparatus and the control apparatus. For example, one aspect of the invention may provide a method (a control method for the printing apparatus) including processing processes performed by components of the foregoing printing apparatus, and a storage medium including stored thereon a program (a control program for the printing apparatus) that causes predetermined hardware (e.g., a computer incorporated in the printing apparatus) to execute functions of the components of the foregoing printing apparatus. Likewise, one aspect of the invention may also provide even a method including processing steps performed by components of the foregoing control apparatus, and a storage medium including stored thereon a program that causes a computer to execute functions of components of the foregoing control apparatus. Furthermore, a system including a control apparatus and a printing apparatus may be regarded as an embodiment of the invention.

### BRIEF DESCRIPTION OF THE DRAWINGS

The invention will be described with reference to the accompanying drawings, wherein like numbers reference like elements.

FIG. 1 simply illustrates configurations of a PC and a printer.

FIG. 2 is a block diagram illustrating program functions implemented in the PC and the printer.

FIG. 3 is a flowchart illustrating processing performed in the PC in a first embodiment.

FIG. 4 is a flowchart illustrating processing performed in the printer in the first embodiment.

FIG. 5 is a flowchart illustrating processing performed in the PC in a second embodiment.

FIG. 6 is a flowchart illustrating processing performed in the printer in the second embodiment.

### DESCRIPTION OF EXEMPLARY EMBODIMENTS

Embodiments of the invention are described below with reference to the accompanying drawings.

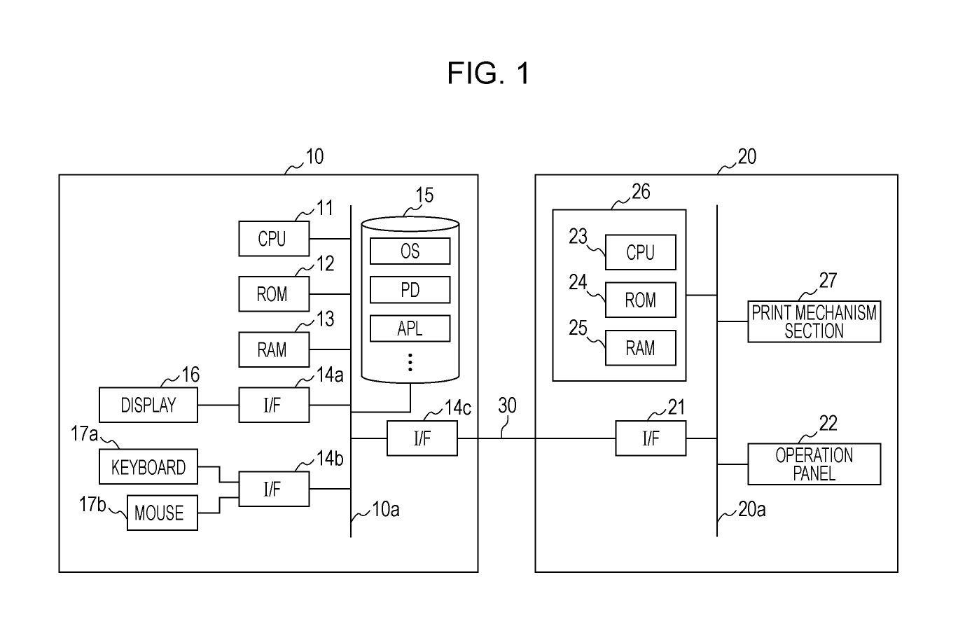

FIG. 1 simply illustrates configurations of a PC 10 as a control apparatus and a printer 20 as a printing apparatus according to the embodiments. In the PC 10, a central processing unit (CPU) 11 serving as the center of computing controls the entire PC 10 via a bus 10a. Connected to the bus 10a are a read only memory (ROM) 12, a random access memory (RAM) 13, various interfaces (I/F) 14a to 14c, a hard disk drive (HDD) 15 and the like. An operating system OS is stored in the HDD 15. Various programs such as a printer driver PD and an application program APL can also be stored in the HDD 15. These various programs are appropriately transferred to and executed in the RAM 13 by the CPU 11. A display 16 configured to display an image based on image data is connected to the I/F 14a, and input devices such as a keyboard 17a and a mouse 17b are connected to the I/F 14b. The I/F 14c is a USB interface, and the I/F 14c can be connected via a USB cable 30 to the printer 20.

The printer 20 is a printing apparatus controlled by the PC 10. The PC 10 performs setup for causing the printer 20 to be in a print ready state. In the printer 20, an I/F 21, an operation panel 22, a printer control IC 26 and the like are connected via a bus 20a. The printer control IC 26 includes a CPU 23, a ROM 24, a RAM 25 and the like. The I/F 21 is a USB interface and can be connected via a USB cable 30 to the PC 10. The operation panel 22 is made up of a liquid crystal display, a touch panel, a light emitting diode (LED), various buttons and the like, and receives an input from the user and presents information to the user.

In the printer control IC 26, the CPU 23 controls the entire printer 20 by performing processing according to predetermined firmware stored in the ROM 24 using the RAM 25 as a work area as appropriate. The printer 20 includes a print mechanism section 27 whose drive is controlled by the printer control IC 26 at the time of print processing. In cases where the printer 20 is an ink jet printer, the print mechanism section 27 includes a print head configured to discharge ink droplets, a carriage configured to cause the print head to perform a main scan, a paper feed mechanism configured to feed sheets of paper, and the like. In the printer 20, an application specific integrated circuit (ASIC) configured to perform predetermined processing (e.g., image processing of image data representing an image to be printed) may be mounted separately from the printer control IC 26. It is to be noted that the printer 20 may be a page printer or a line head printer.

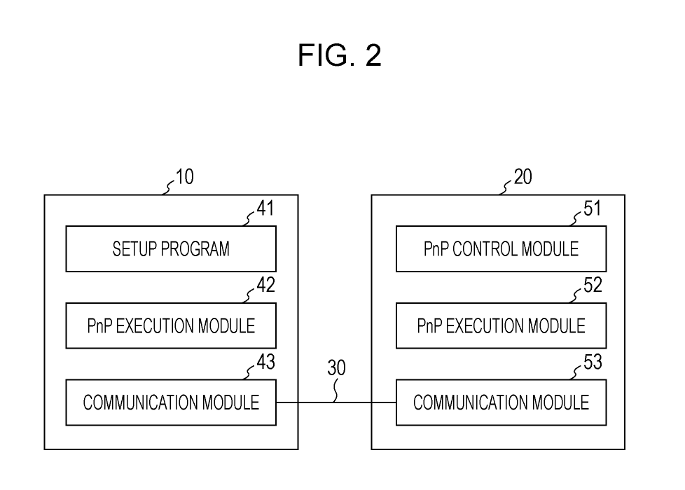

FIG. 2 is a block diagram illustrating program functions implemented in the PC 10 and the printer 20 of the embodiments. In the PC 10, the CPU 11 implements a setup program 41, a PnP execution module 42 and a communication module 43 on the OS. In the printer 20, the CPU 23 implements a PnP control module 51, a PnP execution module 52 and a communication module 53. PnP is the abbreviation for Plug and Play. The communication module 43 and the communication module 53 are USB drivers and implement USB communication between the PC 10 and the printer 20 whose I/F 14c and I/F 21 are connected with each other via the USB cable 30.

The PnP execution module 42 and the PnP execution module 52 are each functions as follows. When a connection between the PC 10 and the printer 20 is established with the USB cable 30 to allow the USB communication, with this connection acting as a trigger, the PnP execution module 42 and the PnP execution module 52 can automatically start predetermined communication processing required for performing setup. That is, the PnP execution module 42 and the PnP execution module 52 are each functions for executing PnP. The setup program 41 and the PnP control module 51 in the embodiments are functions for controlling prohibition on PnP and cancellation of the prohibition. The setup program 41 also has functions for providing guide screens to be described later to users, and the like. Hereinbelow, each of the embodiments at the stage of performing setup of the printer 20 will be described.

### First Embodiment

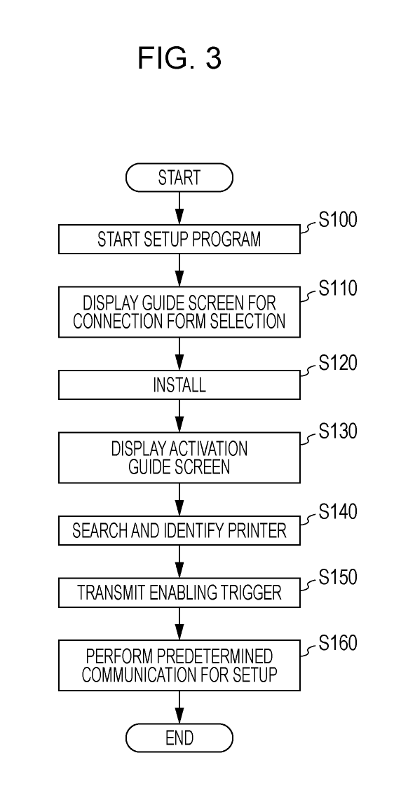

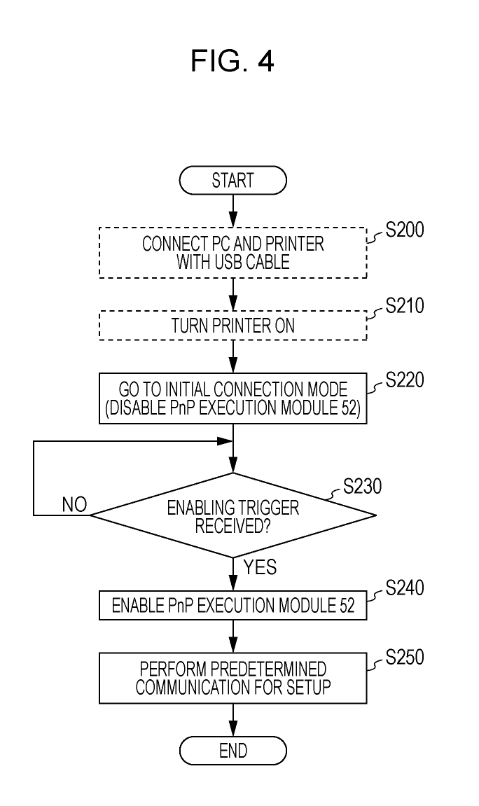

FIG. 3 is a flowchart illustrating processing performed by the above-mentioned functions on the side of the PC 10 in the first embodiment, and FIG. 4 is a flowchart illustrating processing performed by the above-mentioned functions on the side of the printer 20 in the first embodiment.

In step S100 (FIG. 3), responding to a user's operation, the PC 10 reads the setup program 41 from a compact disk read-only memory (CD-ROM) included with the printer 20, or via the Internet, to start the setup program 41. It is to be noted that the setup program 41 (or a program corresponding to the setup program 41) need not be a program to be read from the outside by the PC 10 but may be one component on the OS included in advance in the PC 10.

In step S110 (FIG. 3), the PC 10 causes a guide screen to be displayed on a display 16. This guide screen is used for prompting a user to select how the PC 10 and the printer 20 are connected to each other and to connect them in the selected manner (hereinafter that guide screen is referred to as a “guide screen for connection form selection”). Specifically, the PC 10 causes guide screens for teaching a user the procedure for setup in accordance with the setup program 41 to appear on the display 16, and displays the guide screen for connection form selection as one of the guide screens.

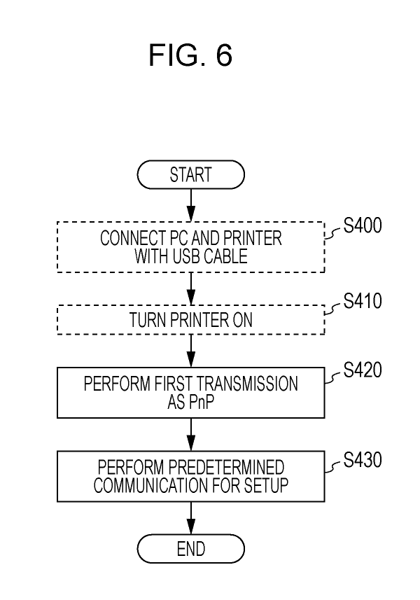

A user viewing the guide screen for connection form selection is allowed to select any connection form among a plurality of connection forms (e.g., USB connection, wired LAN connection and wireless LAN connection) proposed in the guide screen and to connect the PC 10 and the printer 20 in the selected connection form. The guide screen for connection form selection contains, for example, a message “In the case of USB connection, the PC and the printer are directly connected with a USB cable”. In this embodiment, the description is continued under the assumption that a user selects USB connection. Accordingly, ideally, at the timing (step S200 of FIG. 4) after a guide screen for connection form selection has been presented to a user, the user connects the PC 10 and the printer 20 with the USB cable 30. In FIG. 4 (and FIG. 6 to be referred to later), an operation by a user is indicated by a rectangle of a chain line.

In step S120 (FIG. 3), the PC 10 installs various kinds of programs (such as a printer driver PD) required for using the printer 20. These various programs can be read via the CD-ROM or the Internet mentioned above. The processing of step S120 may be performed concurrently with that of step S110.

At the timing when installation of the various required programs has been completed, the PC 10 displays a guide screen (activation guide screen) for prompting the user to activate the printer 20 on the display 16 in step S130 (FIG. 3). On the activation guide screen, a message “Power on the printer”, for example, is displayed.

Accordingly, ideally, at the timing (step S210 of FIG. 4) after the activation guide screen has been presented to the user, a user presses down a power button provided on the printer 20 to turn the printer 20 on. In the first embodiment, the printer 20 is programmed to automatically enter an initial connection mode when the power button is pressed down for the first time after shipment from the factory (i.e., when the user presses down the power button for the first time after purchasing the printer 20). As a result, in step S220 (FIG. 4), the printer 20 enters the initial connection mode.

The printer 20 may be provided with a dedicated button for starting the initial connection mode, in addition to the power button. When the dedicated button is pressed down, the printer 20 may be turned on and automatically enter the initial connection mode. Both the power button and the dedicated button are part of buttons that make up the operation panel 22. Alternatively, when the power button is pressed down to activate the printer 20, the printer 20 may be designed such that a predetermined menu is displayed on a liquid crystal display of the operation panel 22 to allow a user to select the initial connection mode. By providing the dedicated button and allowing selection of the initial connection mode through the menu display in such a manner, a user can set the printer to the initial connection mode not only when connecting the printer to a PC for the first time after purchasing the printer, but also when connecting the printer to a PC that is different from the previously used PC and performing setup operations, and the like.

In any case, in the first embodiment, as the processing in accordance with the setup program 41, in step S130 mentioned above, the PC 10 displays the aforementioned activation guide screen that is intended to guide a user so that, as a result, the printer 20 is activated and enters the initial connection mode. The initial connection mode corresponds to a specific operation mode in the invention. In the printer 20 that has been turned on and has become the initial connection mode by any one of pressing down of the power button, pressing down of the dedicated button, and selection of the initial connection mode from the aforementioned menu after pressing down of the power button, by a user, the PnP control module 51 prohibits the PnP execution module 52 from operating (step S220). As described above, the PnP execution module 52 can execute PnP when the PC 10 and the printer 20 are connected to each other with the USB cable 30 to allow USB communication between the PC 10 and the printer 20. However, the PnP control module 51, in the initial connection mode, disables the function of the PnP execution module 52 until the PnP control module 51 recognizes the occurrence of an “enabling trigger” to be described later.

As a result, it becomes impossible for the PnP execution module 52 to perform predetermined communication processing (transmission processing from the PnP execution module 52 itself, and responding to transmission from the side of the PC 10) required for performing setup of the printer 20 via the communication module 53, the USB cable 30 and the communication module 43. However, in such a state that the PC 10 and the printer 20 are connected to each other with the USB cable 30 and both the PC 10 and the printer 20 are turned on, the communication module 53 and the communication module 43 themselves work, and therefore basic USB communication between the PC 10 and the printer 20 is available except for the predetermined communication based on PnP.

In step S140 (FIG. 3), the PC 10 performs searching and identification of the printer 20 to be set up, as the processing in accordance with the setup program 41. In this case, the PC 10 causes the communication module 43 to transmit a printer search signal from the I/F 14c via the USB cable 30. If the PC 10 receives a reply to the search signal within a predetermined time limit, the PC 10 identifies a printer that has made the reply (here the printer 20) as a printer to be set up. The processing of step S140 may be performed concurrently with that of step S130.

In step S150 (FIG. 3), the PC 10 transmits a specific command (enabling trigger) corresponding to permission for execution of PnP to the printer (the printer 20) identified in step S140, as the processing in accordance with the setup program 41. In this case, the PC 10 causes the communication module 43 to transmit an enabling trigger from the I/F 14c via the USB cable 30 to the printer 20. On the other hand, on the side of the printer 20, the PnP control module 51, in the initial connection mode, always or regularly monitors whether the communication module 53 has received the enabling trigger via the I/F 21 (step S230 of FIG. 4). If the PnP control module 51 determines that the enabling trigger has been received, then the PnP control module 51 proceeds to step S240 (FIG. 4). With respect to receiving the enabling trigger in such a manner, it can be said that the communication module 53 and the PnP control module 51 function as permission receiving units.

In step S240, the PnP control module 51 cancels the prohibition of operation of the PnP execution module 52 (enabling the PnP execution module 52 to function). As a result, the PnP execution module 52 performs predetermined communication required for the setup with the PnP execution module 42 on the side of the printer 20 via the communication module 53, the USB cable 30 and the communication module 43 (step S250 of FIG. 4 and step S160 of FIG. 3). Such communication is performed between the PC 10 and the printer 20, and, in parallel with this, the setup program 41 provides interaction with a user through guide screens on the display 16 of the PC 10. Through these communication options, various settings such as setting of a printer name and an IP address and creation of a printer port, which are required when the PC 10 uses the printer 20 as an output device, are performed. Thus, the setup is completed.

As such, according to the first embodiment, when the printer 20 is activated and is in the initial connection mode, first, the function of the PnP execution module 52 is disabled to prevent PnP from working under conditions where USB communication between the printer 20 and the PC 10 can be made, and the function of the PnP execution module 52 is enabled if an enabling trigger is received from the side of the PC 10. In the foregoing description, an ideal procedure has been described in which, in step S110, a user connects the PC 10 and the printer 20 with the USB cable 30 in accordance with an instruction of a guide screen displayed by the PC 10, and, in step S130, the user activates the printer 20 in accordance with an instruction of a guide screen displayed by the PC 10. However, in actuality, a user does not always perform operations in such an ideal procedure in accordance with the instructions of the setup program 41. For example, there is a possibility that before the PC 10 installs various programs (such as a printer driver PD) in step S120, the user connects the printer 20 to the PC 10 and turns the printer 20 on.

According to the first embodiment, even if the printer 20 is connected to the PC 10 at a timing different from such an ideal timing, in the printer 20 in the initial connection mode, PnP is prevented from working until the above-mentioned installation on the side of the PC 10 and searching for the printer 20 by the PC 10 are completed (i.e., until an enabling trigger is transmitted). That is, by controlling the timing of occurrence of PnP, predetermined communication processing for setup to be realized by PnP can be performed at an ideal timing. Accordingly, the setup of the printer 20 is appropriately performed, as a matter of course, in cases where the procedure performed by a user is proper, and even in cases where the procedure performed by a user is improper. Therefore, the load on a user required for performing the setup is reduced.

It is to be noted that the printer 20 itself may generate the above-mentioned enabling trigger. In this case, the printer 20 has a configuration in which a trigger generation button is included as part of buttons that make up the operation panel 22. A user can press down the trigger generation button at an arbitrary timing for the printer 20 in the initial connection mode. Upon detecting the pressing down of the trigger generation button, the CPU 23 causes an enabling trigger to be generated inside the printer 20. With respect to being able to generate an enabling trigger, it can be said that the printer 20 functions as a permission generating unit of the invention. If, at the time when the PnP control module 51 detects generation of such an internal enabling trigger, the function of the PnP execution module 52 is disabled, the PnP control module 51 enables the function of the PnP execution module without waiting for transmission of an enabling trigger from the PC 10. With such a configuration, a user can enable the PnP function in the printer 20 at an arbitrary timing.

### Second Embodiment

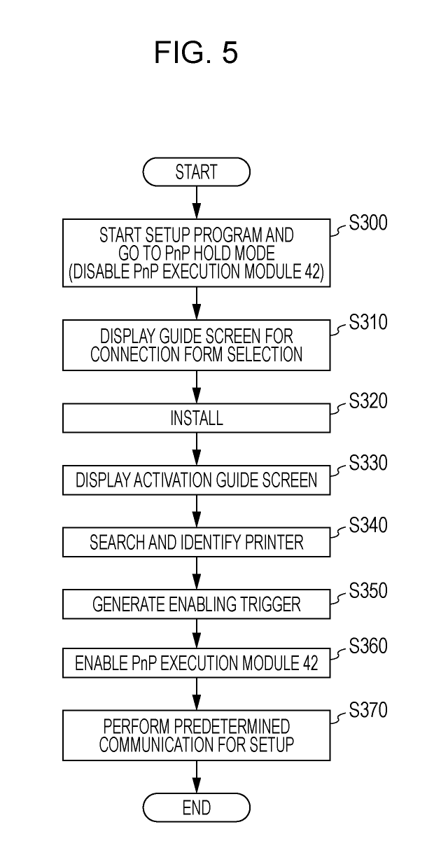

FIG. 5 is a flowchart illustrating processing performed by the above-mentioned functions on the side of the PC 10 in the second embodiment, and FIG. 6 is a flowchart illustrating processing performed by the above-mentioned functions on the side of the printer 20 in this embodiment.

In step S300 (FIG. 5), responding to a user's operation, the PC 10 starts the setup program 41, and enters the PnP hold mode in step with the start of the setup program 41. In the PC 10 in the PnP hold mode, the setup program 41 prohibits the PnP execution module 42 from operating (disabling the function of the PnP execution module 42). That is, in the second embodiment, the setup program 41 functions as a plug-and-play control unit in the control apparatus.

Step S310 (FIG. 5) is the same as step S110 (FIG. 3). Accordingly, like in the first embodiment, ideally, at the timing (step S400 of FIG. 6) after a guide screen for connection form selection has been presented to a user, the user connects the PC 10 and the printer 20 with the USB cable 30. Step S320 (FIG. 5) is the same as step S120 (FIG. 3). Processing of step S320 may be performed concurrently with that of step S310. At the timing when the aforementioned installation has been completed, the PC 10 displays a guide screen (activation guide screen) for prompting the user to activate the printer 20 on the display 16 in step S130 (FIG. 3). On the activation guide screen, a message “Power on the printer”, for example, is displayed.

Accordingly, like in the first embodiment, ideally, at the timing (step S410 of FIG. 6) after the activation guide screen has been presented to the user, the user presses down a power button provided on the printer 20 to turn the printer 20 on. In the printer 20 that has been turned on, the PnP execution module 52 produces PnP (step S420 of FIG. 6). That is, the PnP execution module 52 causes the communication module 53 to perform first signal transmission as the aforementioned predetermined communication processing required for performing setup. The communication module 53 transmits a predetermined signal from the I/F 21 through the USB cable 30 to the side of the PC 10. However, as described above, in the PC 10 in the PnP hold mode, the function of the PnP execution module 42 is disabled.

Accordingly, even when the communication module 43 receives the predetermined signal through the I/F 14c, the PnP execution module 42 puts a response to that predetermined signal on hold (cannot respond). In other words, due to the PC 10 in the PnP hold mode, the aforementioned predetermined communication processing required for performing setup is prevented from progressing. However, in such a state that the PC 10 and the printer 20 are connected to each other with the USB cable 30 and both the PC 10 and the printer 20 are turned on, the communication module 53 and the communication module 43 themselves work, and therefore basic USB communication between the PC 10 and the printer 20 is available except the predetermined communication based on PnP.

Step S340 (FIG. 5) is the same as step S140 (FIG. 3). Processing of step S340 may be performed concurrently with that of step S330. In step S350 (FIG. 5), the setup program 41 generates a specific command (enabling trigger) corresponding to permission for the PnP execution module 42 to execute PnP. That is, in the second embodiment, the setup program 41 functions also as a permission generating unit in the control apparatus. In such a case where an enabling trigger is generated by the function of the setup program 41, in step S360 (FIG. 5), the prohibition of operation of the PnP execution module 42 is cancelled (enabling the PnP execution module to function).

As a result, the PnP execution module 42 performs the aforementioned predetermined communication processing required for performing the setup whose progress has been stopped. This processing is performed between the PnP execution module 42 and the PnP execution module 52 on the side of printer 20 via the communication module 43, the USB cable 30 and the communication module 53 (step S370 of FIG. 5 and step S430 of FIG. 6). Such communication is performed between the PC 10 and the printer 20, and, in parallel with this, the setup program 41 provides interaction with a user through guide screens on the display 16 of the PC 10. Through these communication options, various settings such as setting of a printer name and an IP address and creation of a printer port, which are required when the PC 10 uses the printer 20 as an output device, are performed. Thus, the setup is completed.

As such, according to the second embodiment, the PC 10 enters the PnP hold mode in step with the start of the setup program 41, and the PC 10 disables the function of the PnP execution module 42. Thus, even when PnP occurs on the side of the printer 20 whose USB communication with the PC 10 has become possible, the PC 10 puts a response to the PnP on hold and generates an enabling trigger at a predetermined timing to enable the PnP execution module 42 to function. As described above, in actuality, a user does not always perform operations in an ideal procedure in accordance with instructions of the setup program 41. For example, there is a possibility that before the PC 10 installs various programs (such as a printer driver PD) in step S320, or right at the beginning before the start of the setup program 41, the user connects the printer 20 to the PC 10 and turns the printer 20 on.

According to the second embodiment, even if the printer 20 is connected to the PC 10 at a timing different from such an ideal timing, the PC 10 enters the PnP hold mode immediately upon the start of the setup program 41, and stops the progress of operation of PnP at a point where the first response to occurrence of PnP from the side of the printer 20 is not yet performed until the aforementioned installation and searching for the printer 20 are completed (until an enabling trigger is generated). That is, by controlling the timing of occurrence of PnP, predetermined communication processing for setup to be realized by PnP can be performed at an ideal timing. Accordingly, the setup of the printer 20 is appropriately performed, as a matter of course, in cases where the procedure performed by a user is proper, and even in cases where the procedure performed by the user is improper. Therefore, the load on a user required for performing the setup is reduced.

The invention is not limited to the embodiments described above and can be implemented in various forms without departing from the scope and the spirit of the invention.

What is claimed is:

1. A printing apparatus including a plug-and-play execution unit capable of performing predetermined communication processing with an external control apparatus, the predetermined communication processing being triggered by a connection with the control apparatus when the connection is established via a predetermined communication path, the printing apparatus comprising:
a plug-and-play control unit configured to prohibit the plug-and-play execution unit from operating in a case where an instruction for activating the printing apparatus according to a specific operation mode is received from an outside source, so that the plug-and-play execution unit is prevented from performing the communication processing even with the control apparatus and the printing apparatus connected; and
a permission receiving unit configured to receive permission for execution of plug and play via the communication path from the control apparatus,
wherein, in a case where the permission for execution is received, the plug-and-play control unit cancels the prohibition of operation of the plug-and-play execution unit to cause the plug-and-play execution unit to perform the communication processing.

2. The printing apparatus according to claim 1, further comprising a permission generating unit configured to generate permission for execution of plug and play,
wherein the plug-and-play control unit cancels the prohibition of operation of the plug-and-play execution unit in a case where the permission generating unit generates permission for execution.

3. The printing apparatus according to claim 1, wherein the communication processing is communication required for the control apparatus to set the printing apparatus to a print ready state.

4. A method of controlling a printing apparatus capable of executing plug and play that performs performing predetermined communication processing with an external control apparatus, the predetermined communication processing being triggered by a connection with the control apparatus when the connection is established via a predetermined communication path, the method comprising:
disabling the plug and play by prohibiting the plug and play in a case where an instruction for activating the printing apparatus according to a specific operation mode is received from an outside source, so that the communication processing is not performed even with the control apparatus and the printing apparatus connected;
receiving permission for execution of plug and play via the communication path from the control apparatus; and
enabling the plug and play by cancelling the prohibition of the plug and play in a case where the permission for execution is received, so that the communication processing is performed.

5. A storage medium comprising stored thereon a control program for a printing apparatus capable of executing plug and play that performs predetermined communication processing with an external control apparatus, the predetermined communication processing being triggered by a connection with the control apparatus when the connection is established via a predetermined communication path, the control program causing a computer to execute a function of causing the printing apparatus to perform the functions of:
disabling the plug and play by prohibiting the plug and play in a case where an instruction for activating the printing apparatus according to a specific operation mode is received from an outside source, so that the communication processing is prevented from being performed even with the control apparatus and the printing apparatus connected;
receiving permission for execution of plug and play via the communication path from the control apparatus; and
enabling the plug and play by cancelling the prohibition of the plug and play in a case where the permission for execution is received, so that the communication processing is performed.

6. A control apparatus including a plug-and-play execution unit capable of performing predetermined communication processing with an external printing apparatus, the predetermined communication processing being triggered by a connection with the printing apparatus when the connection is established via a predetermined communication path, the control apparatus comprising:
a plug-and-play control unit configured to prohibit the plug-and-play execution unit from operating, when performing predetermined setting for the printing apparatus, so that, in a case where signal transmission as part of the communication processing is performed via the communication path from the printing apparatus, a response to the signal transmission is put on hold to prevent the communication processing from progressing; and
a permission generating unit configured to generate permission for execution of plug and play at a predetermined timing,
wherein, in a case where the permission generating unit generates permission for execution, the plug-and-play control unit cancels the prohibition of operation of the plug-and-play execution unit to cause the plug-and-play execution unit to advance the progress of the communication processing.

7. The control apparatus according to claim 6, wherein the permission generating unit generates the permission for execution at a timing when the printing apparatus for which the predetermined setting is to be performed is specified via the communication path.

8. The control apparatus according to claim 6, wherein the communication processing is communication required for the control apparatus to set the printing apparatus to a print ready state.
